(19) United States
(12) Patent Application Publication
(10) Pub. No.: US 2016/0240894 A1
(43) Pub. Date: Aug. 18, 2016

(54) Battery Management System for Monitoring and Regulating the Operation of a Rechargeable Battery, and Battery System with such a Battery Management System

(71) Applicants: ROBERT BOSCH GMBH, Stuttgart (DE); SAMSUNG SDI CO., LTD., Yongin-si, Gyeonggi-do (KR)

(72) Inventors: Axel Wartenberg, Karlsruhe (DE); Joachim Fetzer, Bad-Ditzenbach (DE); Hans-Joerg Wolff, Schorndorf (DE); Martin Lang, Hessigheim (DE); Peter Fischer, Gerlingen (DE)

(21) Appl. No.: 15/029,158

(22) PCT Filed: Sep. 30, 2014
(86) PCT No.: PCT/EP2014/070849

§ 371 Date: Apr. 13, 2016

(30) Foreign Application Priority Data
Oct. 14, 2013 (DE) 102013220684.4

(51) Int. Cl. H01M 10/42; H01M 2/20

(52) U.S. Cl. CPC H01M 10/4257; H01M 10/4207; H01M 2/206; H01M 2010/4271; H01M 2220/20

(57) ABSTRACT

The disclosure relates to a battery management system for monitoring and regulating the operation of a rechargeable battery that has a plurality of electrically interconnected battery modules, each of which comprises at least one battery cell. The battery management system comprises a controller unit and a cell monitoring unit. The cell monitoring unit is designed to receive data relating to an operating parameter of a battery cell, to detect the received data, and to transmit the detected data to the controller unit. Furthermore, the cell monitoring unit is designed to detect at least one fault event with respect to the battery cell and to trigger a deactivation of the battery module comprising the battery cell. The disclosure further relates to a battery system with a plurality of electrically interconnected battery modules, each of which comprises at least one battery cell, and with a battery management system according to the disclosure.

The invention relates to a battery management system for monitoring and regulating the operation of a rechargeable battery which has a plurality of electrically interconnected battery modules in each case comprising at least one battery cell, wherein the battery management system comprises at least one control unit and at least one cell monitoring unit, and wherein the at least one cell monitoring unit is designed to receive data relating to at least one battery parameter of at least one battery cell, to collect the received data and transmit the collected data to the at least one control unit.

In addition, the present invention relates to a battery system with a plurality of electrically interconnected battery modules (3) which in each case comprise at least one battery cell (2), and with a battery management system.

### PRIOR ART

Battery systems of this type are used, in particular, in hybrid, plug-in hybrid and electric vehicles to provide the electrical energy required for operation. Rechargeable lithium ion cells, in particular, are used as battery cells. Battery systems are known in which the battery cells are connected in series with a battery. In addition, battery systems are known which comprise a plurality of battery modules, wherein a battery module in each case has a plurality of series-connected or parallel-connected battery cells. In particular, battery systems of this type are also known in which a plurality of battery modules are connected via coupling units in series and/or in parallel to form a battery string, wherein, by means of the coupling units, individual battery modules can be connected to the battery string and/or individual battery modules can be bypassed and can thus be disconnected from the battery string. Interconnections of this type of connectable or disconnectable battery modules are known by the terms Battery Direct Converter (BDC) and Battery Direct Inverter (BDI).

Battery Management Systems (BMS) are used particularly in order to ensure the safety of a battery system, to make full use of the capacity of the battery cells and/or to increase the service life of the battery cells. Important functions of these battery management systems are battery state detection, which determines the current state of the battery cells of the battery system, communication with other systems, in particular control systems of a vehicle, and/or performance of the thermomanagement of the battery cells. To do this, hitherto known battery management systems have, in particular, at least one control unit and a plurality of cell monitoring units. The cell monitoring units are normally cell supervision circuits which measure operating parameters, such as, in particular, battery cell voltages, battery cell currents and/or battery cell temperatures and transmit them to the at least one control unit.

Different control device architectures are known for the battery management system, in particular an architecture with a central control unit (central BMS system) and an architecture with a distributed BMS control unit (distributed system with and without a daisy chain). In these architectures, the data transmission paths are normally designed as hardwired, i.e. cable-connected, particularly for reasons of availability and safety. A battery sensor is furthermore known from document DE 10 2007 063 280 A1 for use in the aforementioned battery systems in which the data are transmitted wirelessly in order to reduce the wiring outlay.

One major disadvantage of battery systems hitherto known in the prior art is that an occurrence of a fault in the battery system normally results in a complete failure of the battery system. The control unit of the battery management system normally detects a fault and instigates a disconnection of the battery system, if necessary using a Battery Disconnection Unit (BDU), particularly by controlling corresponding contactors of the battery system.

Against this background, one object of the present invention is to increase the availability of a battery system in the event of a fault.

### DISCLOSURE OF THE INVENTION

To achieve the object, a battery management system is proposed for monitoring and regulating the operation of a rechargeable battery which has a plurality of electrically interconnected battery modules in each case comprising at least one battery cell, wherein the battery management system comprises at least one control unit and at least one cell monitoring unit. The at least one cell monitoring unit is designed to receive data relating to at least one operating parameter of at least one battery cell, to collect the received data and transmit the collected data to the at least one control unit. The at least one cell monitoring unit is furthermore designed to detect at least one fault event relating to the at least one battery cell and to instigate a disconnection of the battery module comprising the at least one battery cell.

Operating parameters of at least one battery cell are, in particular, the battery cell voltage and/or the battery cell temperature of the at least one battery cell. Data relating to at least one operating parameter are, in particular, measured values relating to at least one operating parameter, i.e., in particular, measured values relating to the battery cell voltage and/or measured values relating to the battery cell temperature. In particular, it is provided that each battery cell comprises at least one sensor, wherein the at least one sensor measures operating parameters of the battery cell, in particular the battery cell voltage and/or the battery cell temperature. The measured values recorded by the at least one sensor are advantageously transmitted in each case to at least one cell monitoring unit as data relating to at least one operating parameter and are collected by the at least one cell monitoring unit. These collected data can advantageously be transmitted from the at least one cell monitoring unit to the at least one control unit. In particular, it is provided as an advantageous design of the battery management system according to the invention that the at least one cell monitoring unit is a Cell Supervision Circuit (CSC) with extended functional scope. The at least one cell monitoring unit is furthermore advantageously designed to carry out a cell balancing.

According to one further advantageous design of the invention, it is provided that the at least one control unit is a Battery Control unit (BCU). The at least one control unit of the battery management system according to the invention is advantageously designed to evaluate received data, in particular received data relating to at least one operating parameter of at least one battery cell using at least one algorithm. Furthermore, the at least one control unit is advantageously designed to control and/or regulate functions of a battery system depending on the result of the data evaluation, in particular the temperature of the battery cells of a battery system and/or further safety-related functions of a battery system. In particular, it is provided that the at least one control unit is designed to control contactors of the battery system in order to be able to electrically decouple the battery of the battery system and thus, for example, prevent an overcharging of a battery system.

Since the at least one cell monitoring unit of the battery management system according to the invention is designed according to the invention to detect fault events relating to at least one battery cell and instigate a disconnection of the battery module comprising this at least one battery cell, the at least one control unit is advantageously relieved of its load. Consequently, the battery management system advantageously becomes less prone to faults. In particular, the number of faults due to an excessively high data volume to be processed by the at least one control unit is reduced, as a result of which the battery management system advantageously operates more robustly.

Since the disconnection of individual battery modules is furthermore provided by the at least one cell monitoring unit, a battery system can advantageously continue to operate with the remaining battery modules in the event of a fault. Although the system power of a battery system is sometimes reduced as a result, a complete outage is advantageously prevented.

An instigation of a disconnection of the battery module comprising the at least one battery cell by the at least one cell monitoring unit is, in particular, an active control of a switching unit for disconnecting the battery module comprising the at least one battery cell by the at least one cell monitoring unit and/or the transmission of at least one signal by the at least one cell monitoring unit to a control unit of the battery system, wherein the control unit, on receiving the at least one signal, initiates a disconnection of the battery module comprising the at least one battery cell.

According to one particularly advantageous design of the battery management system according to the invention, it is provided that the at least one cell monitoring unit is designed to instigate the disconnection of the battery module comprising the at least one battery cell on detecting the at least one fault event. This means that the detection of a fault event by the at least one cell monitoring unit, in a manner of speaking, triggers the instigation of the disconnection of the battery module comprising the at least one battery cell. In response to the detection of a fault event, the disconnection of the battery module comprising the battery cell concerned is advantageously instigated. Damage to the battery system, in particular damage that would result in a total outage of the battery system, can advantageously be largely avoided as a result.

In particular, it is provided as a further advantageous design of the invention that the at least one cell monitoring unit is designed to generate a disconnect signal in order to instigate a disconnection of the battery module comprising the at least one battery cell. Furthermore, the at least one cell monitoring unit is advantageously designed to transmit the generated disconnect signal. The generation of a disconnect signal is preferably instigated by the detection of a fault event by the at least one cell monitoring unit. The generated disconnect signal is advantageously transmitted by the cell monitoring unit in order to instigate the disconnection of the battery module comprising the at least one battery cell causing the fault event. The disconnect signal is advantageously transmitted from the at least one cell monitoring unit to a switching unit of the battery system via which the battery module concerned is electrically connected to the further battery modules of the battery system. The switching unit may be designed, in particular, by means of semiconductor elements, wherein the reception of the disconnect signal by the switching unit instigates a switching of the switching unit and the battery module concerned is thus advantageously disconnected from the battery system.

The at least one cell monitoring unit is furthermore advantageously designed to detect an absence of reception of data from the at least one battery cell as a fault event. A defective communication connection between the at least one battery cell of a battery module and the at least one cell monitoring unit is thus advantageously also detected as a fault event. In particular, a problem with the at least one battery cell can be prevented from remaining undetected in the event of a defective communication connection. The robustness of the system is advantageously further increased as a result.

According to one further particularly advantageous design of the battery management system according to the invention, it is provided that the at least one cell monitoring unit is designed to evaluate the collected data using at least one algorithm. In particular, it is provided that the at least one cell monitoring unit is designed to determine battery cell characteristics by evaluating the collected data, such as, in particular, the state of charge (SOC) of a battery cell. As a result, the at least one control unit of the battery management system is advantageously further relieved of its load, as a result of which the entire system advantageously becomes less prone to faults. In particular, it is provided that the at least one cell monitoring unit is designed to collect the evaluated data as further data and to transmit the evaluated data as collected data to the at least one control unit. It is thus provided, in particular, that a state of charge (SOC) of a battery cell determined by the at least one cell monitoring unit can be transmitted by the cell monitoring unit to the at least one control unit.

The at least one cell monitoring unit is furthermore advantageously designed to detect the at least one fault event by evaluating the collected data. In particular, it is provided that the at least one cell monitoring unit comprises a comparator unit for this purpose, wherein the exceeding and/or understepping of predefined limit values is detected as a fault event. In particular, it is provided that an implausible value for a state of charge of a battery cell is detected by the at least one cell monitoring unit as a fault event. The number of detectable fault events is advantageously further increased through this design and the operation of a battery system is further improved in terms of availability when a battery management system according to the invention is used.

According to a further particularly advantageous design of the battery management system according to the invention, the at least one cell monitoring unit has a transmit unit for the wireless transmission of data. In particular, the at least one cell monitoring unit is advantageously designed to transmit collected data and/or a generated disconnect signal wirelessly by means of the transmit unit. It is furthermore provided according to a further advantageous design of the invention that the at least one cell monitoring unit has a receive unit for the wireless reception of data. According to one particularly advantageous design of the battery management system according to the invention, it is provided that the transmission and/or reception of data between units of the battery management system is implemented at least partially wirelessly. The wiring outlay is advantageously reduced through the wireless transmission of the data. In particular, it is provided that the wireless transmission of data is implemented by means of a radio technology. In particular, it is provided that a transmission of signals is implemented by means of the industry standard IEEE 802.15.1 (Bluetooth), according to an RFID (radio frequency identification) standard and/or by means of a local radio network, preferably by means of a local radio network according to a standard of the IEEE 802.11 family. In particular, it is provided that the data relating to the at least one operating parameter are wirelessly receivable by the at least one cell monitoring unit.

In order to achieve the aforementioned object, a battery system is furthermore proposed with a plurality of electrically interconnected battery modules which in each case comprise at least one battery cell, and with a battery management system according to the invention, wherein at least one battery cell of a battery module of the battery system is assigned in each case to a cell monitoring unit of the battery management system for the reception of data relating to at least one operating parameter of at least one battery cell. This means that a cell monitoring unit of the battery management system in each case collects the data relating to the at least one operating parameter of the battery cell assigned to the cell monitoring unit. In particular, it is provided that the at least one battery cell has sensors for measuring operating parameters of at least one battery cell, in particular sensors for measuring a battery cell voltage and/or a battery cell temperature. The data collected by the sensors are advantageously transmitted via a communication connection to the at least one cell monitoring unit, are received by the at least one cell monitoring unit and are collected by the at least one cell monitoring unit as data relating to at least one operating parameter. In particular, it is provided that a plurality of battery cells of a battery module are assigned to a cell monitoring unit, in particular all battery cells of a battery module, wherein the battery management system has at least as many cell monitoring units as battery modules.

According to one particularly advantageous design of the battery system, it is provided that the battery system comprises coupling units via which the battery modules of the battery system are electrically interconnected. It is advantageously provided that the battery modules can in each case be electrically connected to the battery system or can be electrically disconnected or isolated from the battery system by means of a coupling unit assigned to the respective battery module. For this purpose, the coupling unit is advantageously designed to electrically disconnect the battery module from the battery system on receiving a disconnect signal, particularly in that the coupling unit electrically bypasses the battery module by means of a corresponding switching procedure. In this design, the battery system advantageously comprises a plurality of battery modules which can advantageously be connected to form a battery string or can be bypassed via the coupling units. The battery modules of the battery system are advantageously connected as a Battery Direct Converter (BDC) or as a Battery Direct Inverter (BDI). In this design, the battery system can advantageously continue to be operated with the remaining battery modules if one or more battery modules fails. The battery modules of the battery system are advantageously additively connectable to the output voltage of the corresponding battery string or are bypassable in the corresponding battery string via the coupling units, so that the battery cells of this battery module make no contribution to the output voltage of the corresponding battery string.

In particular, it is provided that the battery system has a signal transmission path between the coupling unit assigned to a battery module and the at least one cell monitoring unit which is assigned to the at least one battery cell of this battery module. In particular, it is provided that a disconnect signal generated by the at least one cell monitoring unit can be transmitted via this signal transmission path to the coupling unit in order to instigate the disconnection of a battery module of the battery system in this way.

The signal transmission path is advantageously implemented wirelessly, wherein the at least one cell monitoring unit advantageously has a transmit unit for the wireless transmission of the disconnect signal and the respective coupling unit advantageously has a receive unit for the wireless reception of a disconnect signal. As a result, the wiring outlay of the battery system is advantageously further reduced.

Further advantageous details, features and design details of the invention are explained further in connection with the example embodiments shown in the figures, in which:

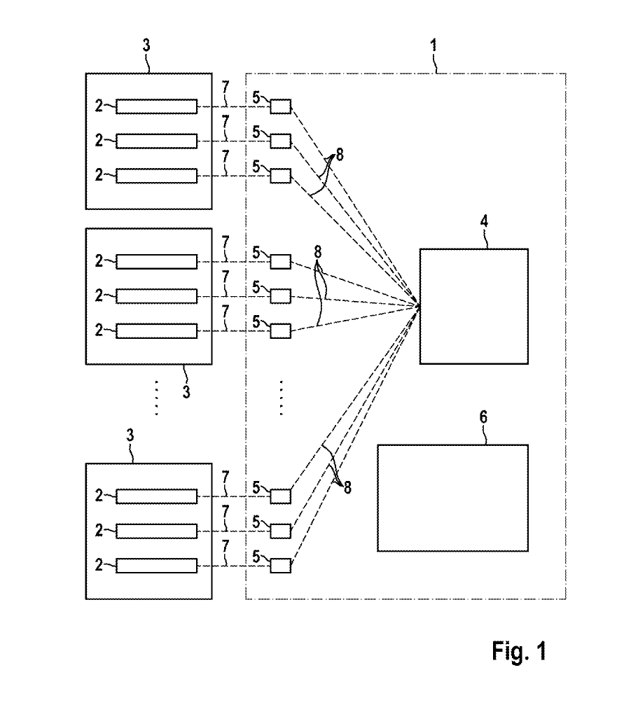

FIG. 1 shows, in a schematic representation, a block diagram of an example embodiment of a battery management system according to the invention;

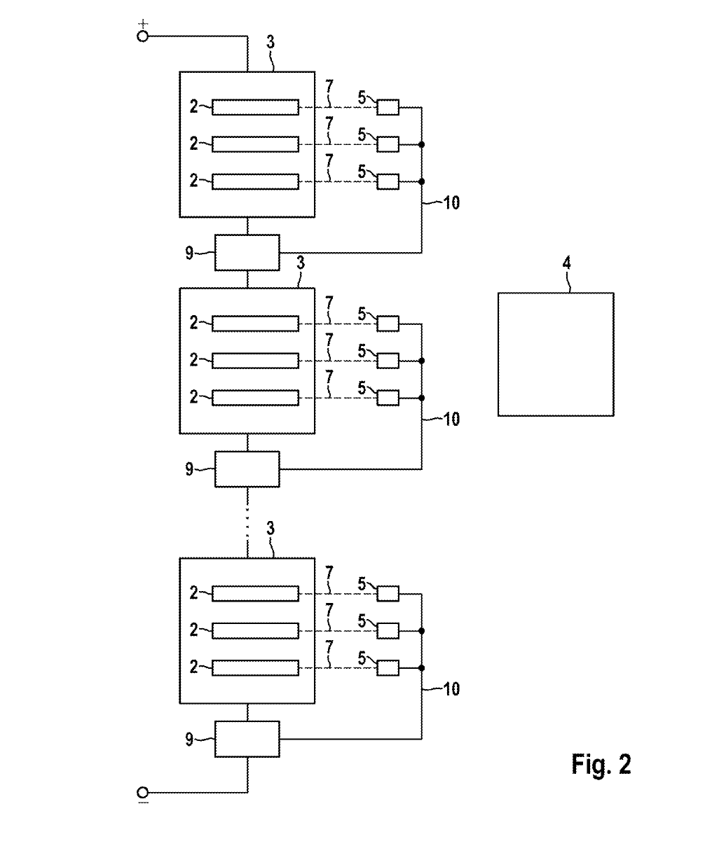

FIG. 2 shows, in a schematic representation, a block diagram of an example embodiment of a battery system according to the invention;

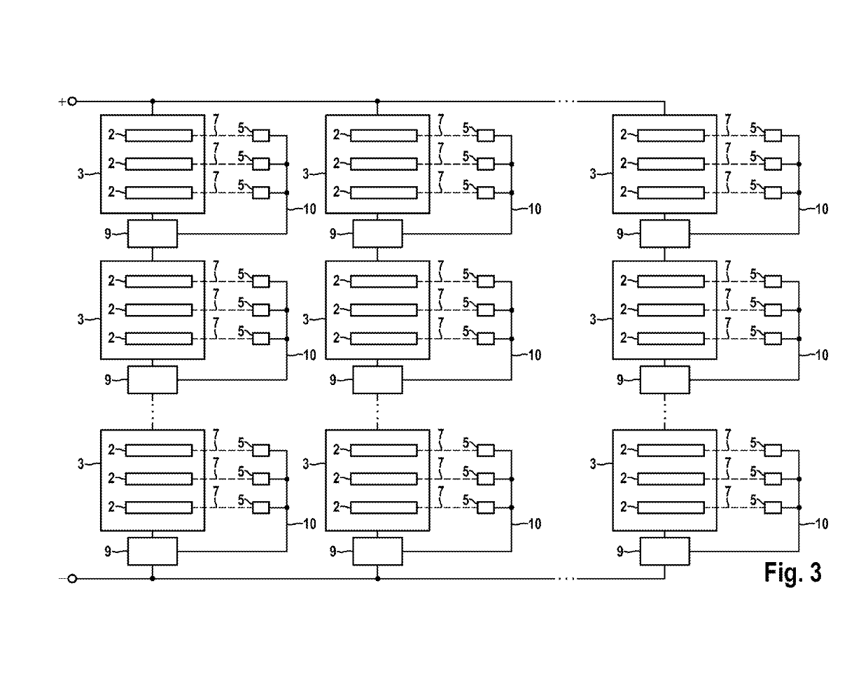

FIG. 3 shows, in a schematic representation, a block diagram of a further example embodiment of a battery system according to the invention; and

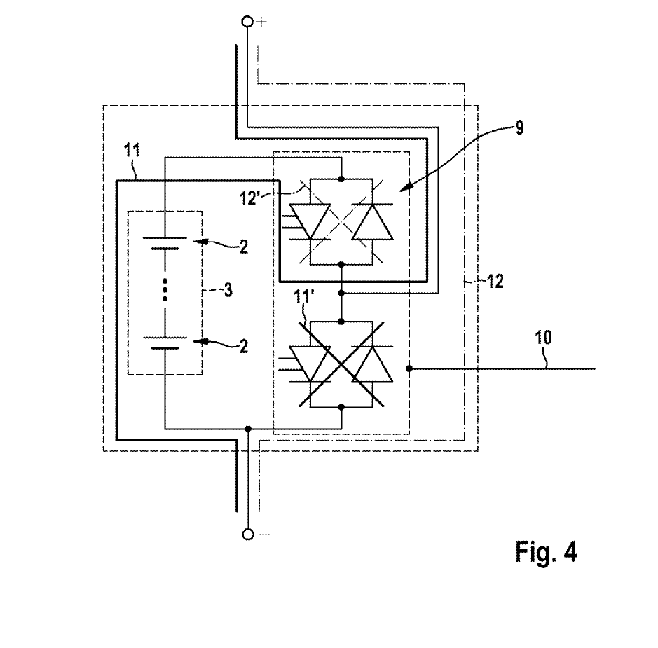

FIG. 4 shows, in a schematic representation, an example embodiment of a battery module of a battery system with a coupling unit assigned to the battery module.

FIG. 1 shows, in a substantially simplified representation, a battery management system 1 for monitoring and regulating the operation of a rechargeable battery which has a plurality of electrically interconnected battery modules 3 in each case comprising at least one battery cell 2. The battery management system 1 comprises a control unit 4 and a plurality of cell monitoring units 5. Furthermore, the battery management system 1 comprises a further functional unit 6 which is designed here to control and/or regulate the temperature of the battery modules 3. The battery cells 2 in each case have sensors (not explicitly shown in FIG. 1) for measuring the battery cell voltage and the battery cell temperature. The measured values collected by the sensors are transmitted via a signal transmission path 7 to the cell monitoring units 5. The cell monitoring units 5 perform, in particular, the tasks of Cell Supervision Circuits (CSC). In particular, the cell monitoring units 5 are designed to carry out a cell balancing. The cell monitoring units 5 are designed in each case to receive, via the signal transmission path 7, the measured values collected by the sensors, to collect the received data and transmit the received data via the signal transmission path 8 to the control unit 4.

The cell monitoring units 5 are furthermore designed to detect a fault event relating to the battery cell 2 to which the respective cell monitoring unit 5 is connected via the signal transmission path 7, and to instigate a disconnection of the battery module 3 comprising this battery cell 2. In particular, the cell monitoring units 5 are designed to detect an absence of reception of the measured values from the respective battery cell 2 as a fault event. This means that, even if a fault occurs in the transmission from a battery cell 2 to a cell monitoring unit 5, this is detected as a fault event. Furthermore, the cell monitoring units 5 are advantageously designed to evaluate collected data using an algorithm. In particular, the cell monitoring units 5 are designed to determine currently prevailing characteristics of the respective battery cell 2, in particular the state of charge (SOC) of a battery cell 2 and/or the state of health (SOH) of a battery cell 2. As a result, the central control unit 4 is advantageously relieved of its load.

Furthermore, the cell monitoring units 5 are advantageously designed to detect a fault event by evaluating collected data. To do this, cell monitoring units comprise, in particular, a comparator unit (not explicitly shown in FIG. 1). By means of the comparator unit, collected and/or evaluated data are subjected to a threshold value comparison, wherein, depending on the respective data, an exceeding and/or an understepping of a predefined threshold value is detected by the cell monitoring units 5 as a fault event.

In the example embodiment shown, the data are transmitted wirelessly via the signal transmission paths 7, 8, preferably according to a radio transmission standard. As a result, the wiring outlay is advantageously reduced.

The battery management system 1 shown in FIG. 1 by way of example has a distributed control unit architecture in which the cell monitoring units 5 communicate with the control unit in a star-shaped architecture.

As an advantageous design variant (not shown in FIG. 1), the following implementations, in particular, of the signal transmission paths are provided for the connection of the cell monitoring units 5:

The communication between the battery cells 2/battery modules 3 and the cell monitoring units 5 is implemented wirelessly. The cell monitoring units 5 are connected to the control unit 4 via a common line-connected bus. Or:

The communication between the battery cells 2/battery modules 3 and the cell monitoring units 5 is implemented wirelessly. The cell monitoring units 5 are furthermore connected in a daisy chain via a line connection to the control unit 4. Or:

The communication between the battery cells 2/battery modules 3 and the cell monitoring units 5 is implemented wirelessly according to the daisy chain principle. The cell monitoring units 5 are furthermore connected via a line connection to the control unit 4. Or:

The communication between the battery cells 2/battery modules 3 and the cell monitoring units 5 is implemented wirelessly. The cell monitoring units 5 are interconnected via a line connection and are wirelessly connected to the control unit 4. Or:

The communication between the battery cells 2/battery modules 3 and the cell monitoring units 5 is implemented wirelessly according to the daisy chain principle. The cell monitoring units 5 are furthermore connected wirelessly to the control unit 4.

FIG. 2 shows, in substantially simplified form as a block diagram, an example embodiment of a battery system with a plurality of battery modules 3 and a battery management system. The battery modules 3 are interconnected via coupling units 9 as a Battery Direct Converter. The battery modules 3 are interconnected to form a battery string, wherein, by means of the coupling units 9, the battery modules 3 can be connected individually to the battery string or can be disconnected from the battery string by bypassing the respective battery module 3. A coupling unit 9 is explained in detail in connection with FIG. 4.

The battery management system comprises a central control unit 4 and a plurality of cell monitoring units 5, as explained in connection with FIG. 1. In particular, the cell monitoring units 5 are designed to collect and evaluate data relating to the battery cell voltage of a group 2 of battery cells 2. In particular, the cell monitoring units 5 are designed to detect a fault event, for example an excessively high battery cell voltage value, during the data evaluation. Furthermore, the cell monitoring units 5 are designed to detect a fault in the signal transmission path 7 between a group 2 of battery cells and the cell monitoring unit 5 as a fault event. On detecting a fault event, the cell monitoring units 5 are furthermore designed to generate a disconnect signal and transmit the disconnect signal via the signal transmission path 10 between the cell monitoring units 5 of a battery module 3 and the coupling unit 9 of this battery module to the coupling unit 9. The reception of the disconnect signal by the coupling unit 9 instigates a switching procedure in the coupling unit 9, whereby the battery module 3 connected via the coupling unit 9 to the battery system is electrically bypassed and is disconnected from the battery system as a result. The cell monitoring units 5 are designed in this way to instigate a disconnection of a battery module 3 of the battery system. The further battery modules 3 of the battery system advantageously remain available. The battery system therefore advantageously remains available despite the occurrence of a fault event.

FIG. 3 shows, in a substantially simplified manner, a battery system in which the battery modules 3 are interconnected as a Battery Direct Inverter (BDI). As explained in connection with the example embodiment in FIG. 2, the battery modules 3 are individually connectable to the battery system and are individually disconnectable from the battery system via coupling units 9, but in extended form. As explained in connection with the example embodiment shown in FIG. 2, fault events are also detectable by the cell monitoring units 5 in the example embodiment shown in FIG. 3, wherein, on detection of a fault event, the disconnection of the battery module 3 comprising the battery cell causing the fault event is instigated by the cell monitoring units 5 in that the respective cell monitoring unit 5 controls the respective coupling unit 9 via the signal transmission path 10.

The mode of operation of a coupling unit 9 is explained by way of example with reference to FIG. 4. For this purpose, the coupling unit 9 in FIG. 4 is implemented with semiconductor elements. A battery module 3 which comprises a plurality of battery cells 2 is electrically connectable via the coupling unit 9 to other battery modules 3 (not shown in FIG. 4) to form a battery or battery string. As the normal state (battery module 3 is connected to the battery system), it is provided that a current flow is enabled via the upper circuit part of the coupling unit 9, so that the battery module 3 is incorporated into the current path 11. The lower circuit part of the coupling unit locks out (shown symbolically by the cross 11′). For the bypassing of the battery module 3 and thus for the disconnection according to the invention of the battery module 3, a signal is transmitted by a cell monitoring unit (not shown in FIG. 4) via the signal transmission path 10 connected to the coupling unit 9, wherein, through reception of the signal, the upper circuit part of the coupling units 9 locks out (shown symbolically by the broken-line cross 12′) and a new current path 12 forms over the upper circuit part of the coupling unit 9 and thus electrically bypasses the battery module 3.

The example embodiments shown in and explained in connection with the figures serve to explain the invention and are not limiting for the latter.

1. A battery management system for monitoring and regulating operation of a rechargeable battery having a plurality of electrically interconnected battery modules, each battery module having at least one battery cell, the battery management system comprising:
at least one control unit; and
at least one cell monitoring unit configured to (i) receive data relating to at least one battery parameter of at least one first battery cell of a first battery module of the rechargeable battery, (ii) collect the received data, (iii) transmit the collected data to the at least one control unit, (iv) detect at least one fault event relating to the at least one first battery cell, and (v) instigate a disconnection of the first battery module.

2. The battery management system as claimed in claim 1, wherein the at least one cell monitoring unit is configured to instigate the disconnection of the first battery module in response to detection of the at least one fault event.

3. The battery management system as claimed in claim 1, wherein the at least one cell monitoring unit is configured to generate and transmit a disconnect signal in order to instigate the disconnection of the first battery module.

4. The battery management system as claimed in claim 1, wherein the at least one cell monitoring unit is configured to detect an absence of reception of data from the at least one first battery cell as the at least one fault event.

5. The battery management system as claimed in claim 1, wherein the at least one cell monitoring unit is configured to evaluate the collected data using at least one algorithm.

6. The battery management system as claimed in claim 1, wherein the at least one cell monitoring unit is configured to detect the at least one fault event by evaluating the collected data.

7. The battery management system as claimed in claim 1, wherein the at least one cell monitoring unit has a transmit unit configured to wirelessly transmit data.

8. The battery management system as claimed in claim 1, wherein the at least one cell monitoring unit has a receive unit configured to wirelessly receive data.

9. A battery system comprising
a plurality of electrically interconnected battery modules, each battery module having at least one battery cell; and
a battery management system comprising:
at least one control unit; and
a plurality of cell monitoring units, each cell monitoring unit being assigned to a at least one first battery cell of a first battery module of the plurality of electrically interconnected battery modules configured to (i) receive data relating to at least one battery parameter of the at least one first battery cell, (ii) collect the received data, (iii) transmit the collected data to the at least one control unit, (iv) detect at least one fault event relating to the at least one first battery cell, and (v) instigate a disconnection of the first battery module,
wherein each battery cell of each battery module has a cell monitoring unit of the plurality of cell monitoring units assigned thereto.

10. The battery system as claimed in claim 9, further comprising:
a plurality of coupling units via which the battery modules (3) of the battery system are electrically interconnected, each coupling units being assigned to one of the battery modules and configured to, in different states, (i) electrically connected the respective battery module to the battery system, (ii) electrically disconnect the respective battery module from the battery system, and (iii) isolate the respective battery module from the battery system, the coupling unit being further configured to electrically disconnect the battery module from the battery system in response to receiving a disconnect signal.

11. The battery system as claimed in claim 10, further comprising:
a plurality of signal transmission paths, each signal transmission path being connected between a coupling unit of the plurality of coupling units and the respective at least one cell monitoring unit assigned to the respective battery module.

12. The battery system as claimed in claim 11, wherein:
each of the plurality of signal transmission paths is implemented wirelessly;
the at least one cell monitoring unit has a transmit unit configured to wirelessly transmit a disconnect signal; and
the respective coupling unit has a receive unit configured to wirelessly receive the disconnect signal.
